(19) United States
(12) Patent Application Publication
(10) Pub. No.: US 2006/0049591 A1
(43) Pub. Date: Mar. 9, 2006

(54) Shopping cart attachment basket

(76) Inventor: Tina M. Pennell, Boise, ID (US)

Correspondence Address: Law Offices of John D. Gugliotta, PE, Esq., 202 Delaware Building, 137 South Main Street, Akron, OH, 44308, US

(21) Appl. No.: 10/931,549

(22) Filed: Sep. 2, 2004

(51) Int. Cl. B62D 39/00

(52) U.S. Cl. 280/33.992

(57) ABSTRACT

A shopping cart basket provides a small, plastic tray or box that clips or hangs on the interior of a shopping cart. The box has approximate dimensions of 6″ wide by 12″ long and 4″ deep. An integral clip allows it to be supported from the sides or front of the shopping cart or the handle section as well. The box has tapered, rounded sides, allowing it to be easily cleaned as well as stackable to save on storage space. It is envisioned that shoppers would take the invention and clip it to the cart when beginning shopping.

### BACKGROUND OF THE INVENTION

1. Field of the Invention

The present invention relates generally to hand cart attachments for material handling and, more particularly, to a removable organizer that attaches to either the cart handle or the cart sidewall.

2. Description of the Related Art

It is common to have experienced the unfortunate incident of losing a small item through the wire bottom of a shopping cart. Even more unfortunately, we usually realize it when we are home, emptying the bags and cannot find the small item or even see that it was rung up on the store receipt, forcing a return trip to the store. These items usually end up on the floor of the store where they must be picked up and returned to the shelves by employees. This results in a loss in the store's profits due to an increase in payable employee time. Even worse is if the item should be stepped on or damaged, and the store must bear the entire cost associated with its loss. Additionally, even if the small item is not lost, the shopper must deal with keeping track of them and picking each one out of the bottom of the cart individually when checking out, resulting in an inconvenience for the shopper.

In looking for a solution to this problem, a search of the prior art did not disclose any patents that read directly on the claims of the instant invention; however, the following references were considered related.

The following patents disclose a shopping list holder for shopping carts.
U.S. Pat. No. 6,029,380 issued in the name of Goddard
U.S. Pat. No. 5,086,960 issued in the name of Schwietzer
U.S. Pat. No. 4,156,318 issued in the name of Economy
U.S. Pat. No. 4,034,539 issued in the name of Economy

The following patents describe a child carrier accessory attachable to a shopping cart.
U.S. Pat. No. 6,022,031 issued in the name of Reiland et al.
U.S. Pat. No. 5,882,021 issued in the name of Reiland et al.
U.S. Pat. No. 5,823,021 issued in the name of Reiland et al.

And, the following patents disclose the design and function of a receptacle article for attachment to a shopping cart.
U.S. Pat. No. 5,947,313 issued in the name of Kern et al.
U.S. Pat. No. D 417,763 issued in the name of Monem
U.S. Pat. No. D 400,679 issued in the name of Kern et al.
U.S. Pat. No. D 400,678 issued in the name of Clark et al.

Consequently, the need has arisen for a manner by which small items can be contained within a large, wire shopping cart that does not result in losing the items or an inconvenience for the shopper.

### SUMMARY OF THE INVENTION

Therefore, it is an object of the invention to provide for an improved shopping cart basket.

It is another object of the present invention to provide for a removable organizer that attaches to either the cart handle or the cart sidewall.

Briefly described according to one embodiment of the present invention, a shopping cart basket provide a small, plastic tray or box that clips or hangs on the interior of a shopping cart. It is envisioned that the box has approximate dimensions of 6″ wide by 12″ long and 4″ deep. An integral clip allows it to be supported from the sides or front of the shopping cart or the handle section as well. The box has tapered, rounded sides, allowing it to be easily cleaned as well as stackable to save on storage space. It is envisioned that shoppers would take the invention and clip it to the cart when beginning shopping. Any small items such as cosmetics, costume jewelry, hardware, or any item that may fall through the wire basket would be placed inside the invention. When the shopper reaches the checkout line, he or she simply unclips the invention, and places it along with its contents on the checkout register. The cashier then removes all of the items, rings them up, and places the invention in a stack that can be collected and used by entering shoppers.

The use of the present invention provides an added convenience to shoppers who may purchase small items and do not want to risk them falling through a wire basket.

Other advantages of the present invention include that it provides for prevents items from falling through basket and becoming lost, as well as being capable of clipping onto sides or front of basket, as well as to handle of shopping cart for easy access.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a shopping cart attachment basket according to the preferred embodiment of the present invention;

FIG. 2 is a side elevational view thereof;

FIG. 3 is a front plan view thereof;

FIG. 4 is a top plan view of a shopping cart attachment basket according to the preferred embodiment of the present invention shown affixed to the handle of a conventional shopping cart;

FIG. 5 is a side elevational view of a shopping cart attachment basket according to the preferred embodiment of the present invention shown affixed to the handle of a conventional shopping cart; and

FIG. 6 is a side elevational view of a shopping cart attachment basket according to the preferred embodiment of the present invention shown affixed to the sloping sidewall of a conventional shopping cart.

### DESCRIPTION OF THE PREFERRED EMBODIMENTS

1. Detailed Description of the Figures

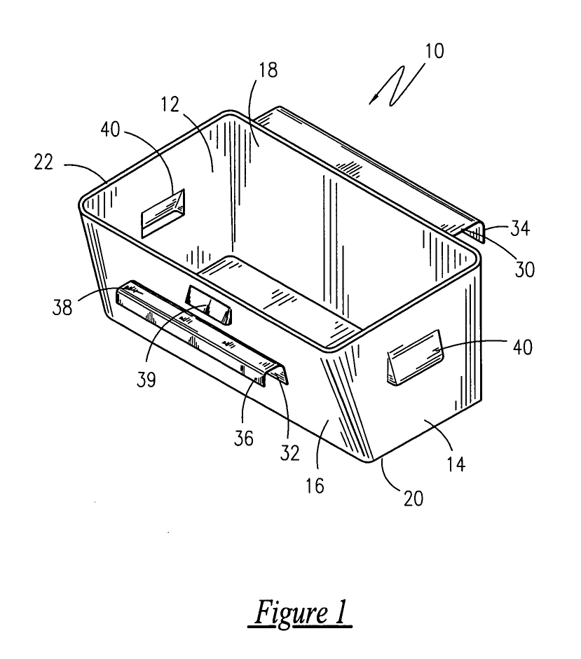

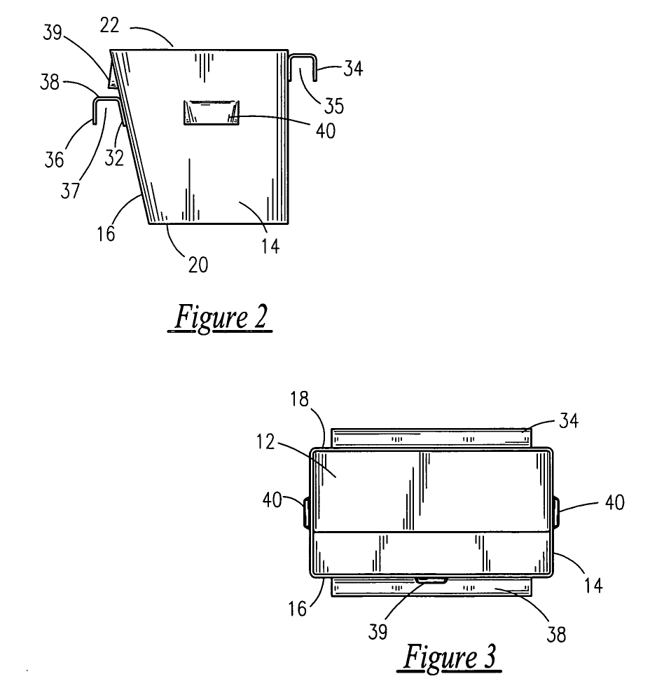

Referring now to FIG. 1-3, a shopping cart attachment basket 10, according to the present invention, forming a retaining volume 12 between a pair of endwalls 14 that intersect with a front sidewall 16 and a rear sidewall 18. A lower surface 20 forms the lowermost portion of the retaining volume 12, opposite an upper rim 22 that circumscribes the perimeter opening of the retaining volume 12. The basket 10 can be further made with tapered, rounded sides, allowing it to be easily cleaned as well as nestingly stackable when not in use to save on storage space. The upper perimeter 22 of the endwalls 14 are parallel to one another, and the upper perimeter of front and rear walls 16 and 18 are parallel to one another. The rear wall 18 is the only vertically upstanding wall, and the front wall 16 and the endwalls 14 are angularly disposed to permit nestability of multiple baskets. The front wall 16 is angularly disposed at a forward incline from the lower surface 20 toward the upper perimeter 22 of the front wall 16. The endwalls 14 are angularly disposed at an outward incline from the lower surface 20 toward the upper perimeter 22 of the endwalls 14. A first retaining hook 30 is integrally formed as an arched extension of the upper rim portion of the rear sidewall 18. The first retaining hook 30 includes a first impingement flange 34 extending downward and parallel to the rear sidewall 18 in a laterally offset manner to form a handle grasping space 35 therebetween. A second retaining hook 32 is formed as an arched extension of the front sidewall 16. The second retaining hook 32 includes a second impingement flange 36 extending downward and parallel to the front sidewall 16 in a laterally offset manner to form a sidewall grasping space 37 therebetween. The arched, upper linear edge 38 of the second retaining hook 32 angularly descends acutely to the upper perimeter rim 22. The upper linear edge angularly descends acutely away from the upper rim, particularly if an imaginary vertical line or axis is drawn from the uppermost portion of the upper rim (shown in FIG. 2 as a point). The angle formed between the imaginary line and the front wall is acute. In either case, it is envisioned that shoppers would take the invention and clip it to the cart when beginning shopping. Any small items such as cosmetics, costume jewelry, hardware, or any item that may fall through the wire basket would be placed inside the invention. When the shopper reaches the checkout line, he or she simply unclips the invention, and places it along with its contents on the checkout register. The cashier then removes all of the items, rings them up, and places the invention in a stack that can be collected and used by entering shoppers.

2. Operation of the Preferred Embodiment

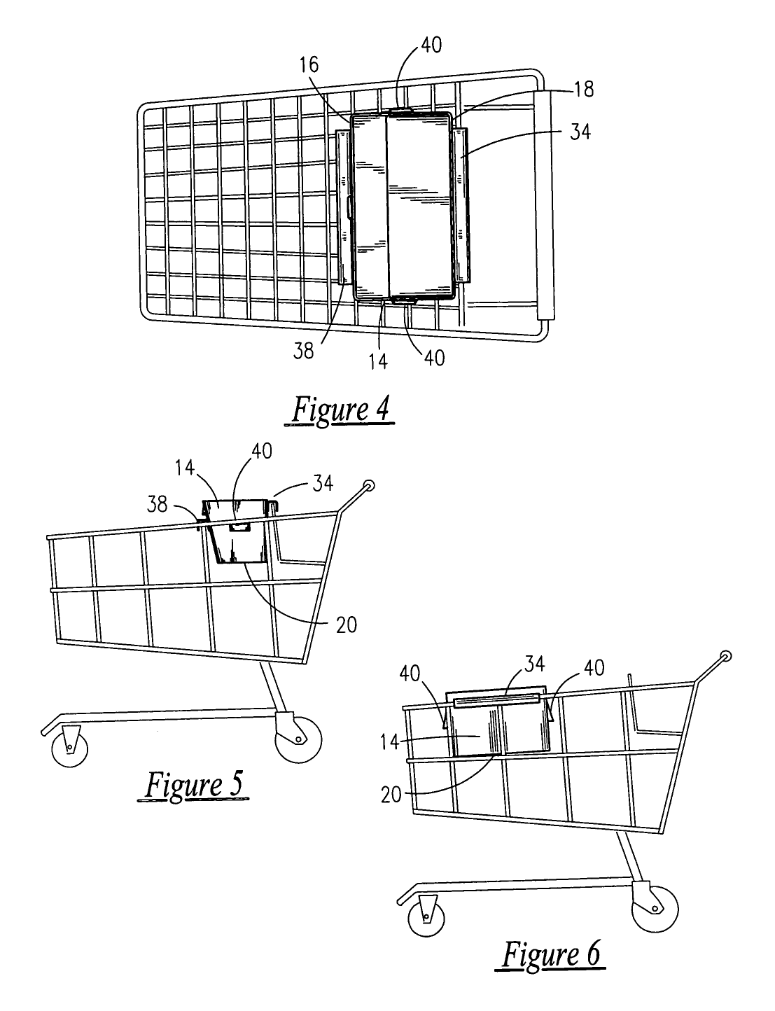

In operation, as shown in FIGS. 4 and 5, the shopping cart attachment basket 10 is mechanically impinged to the handle of a conventional shopping cart. The lateral sidebar of the handle is fitted within the handle grasping space 35 and impinged between the first impingement flange 34 and the rear sidewall 18. Further, the first impingement flange 34 can be spring biased against the handle for provide additional frictional impingement support.

In further operation, as shown in FIG. 6, the shopping cart attachment basket 10 is mechanically impinged to the basket sidewall of a conventional shopping cart. The sidewall is fitted within the sidewall grasping space 37 and impinged between the second impingement flange 36 and the front sidewall 16. Further, the second impingement flange 36 can be spring biased against the sidewall for provide additional frictional impingement support. Because the arched, upper linear edge 38 of the second retaining hook 32 angularly descends acutely to the upper perimeter rim 22, the basket 10 will be supported in a generally horizontal manner, since the conventional basket sidewalls angular descend from a horizontal plane at a similar, acute angle.

As designed, a device embodying the teachings of the present invention is easily applied. The foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. A shopping cart attachment basket forming a retaining volume between a pair of parallel endwalls that intersect with a front sidewall and a rear sidewall opposite to said front sidewall and having a lower surface that forms the lowermost portion of said retaining volume opposite an upper rim that circumscribes a perimeter opening of said retaining volume, said basket further comprising:
a first retaining hook integrally formed as an arched extension of said rear sidewall;
each of said pair of endwalls angularly disposed at an outward incline;
said front sidewall angularly disposed at a forward incline for permitting nestability of multiple said baskets.

2. The shopping cart attachment basket of claim 1, wherein said first retaining hook includes a first impingement flange extending downward and parallel to said rear sidewall in a laterally offset manner to form a handle grasping space therebetween.

3. The shopping cart attachment basket of claim 1, further comprising:
a second retaining hook formed as an arched extension of said front sidewall.

4. The shopping cart attachment basket of claim 3, wherein said second retaining hook includes a second impingement flange extending downward and parallel to the front sidewall in a laterally offset manner to form a sidewall grasping space therebetween.

5. The shopping cart attachment basket of claim 4, wherein the arched, upper linear edge of said second retaining hook angularly descends acutely from the upper perimeter rim, permitting said basket to rest in a generally horizontal manner.

6. The shopping cart attachment basket of claim 2, wherein said first impingement flange is spring biased toward said rear sidewall for providing additional frictional impingement support.

7. The shopping cart attachment basket of claim 4, wherein said second impingement flange is spring biased toward said front sidewall for providing additional frictional impingement support.
